(19) United States
(12) Patent Application Publication
(10) Pub. No.: US 2023/0409843 A1
(43) Pub. Date: Dec. 21, 2023

(54) SEMICONDUCTOR DEVICE

(71) Applicant: Sony Group Corporation, Tokyo (JP)

(72) Inventors: Hiroshi Yoshida, Kanagawa (JP); Jun Okuno, Kanagawa (JP); Hiroki Koga, Kanagawa (JP); Yusuke Shuto, Kanagawa (JP); Takeo Tsukamoto, Kanagawa (JP)

(21) Appl. No.: 18/035,601

(22) PCT Filed: Oct. 29, 2021
(86) PCT No.: PCT/JP2021/039943

§ 371 Date: May 5, 2023

(30) Foreign Application Priority Data
Nov. 13, 2020 (JP) 2020-189198

(51) Int. Cl. G06G 7/16

(52) U.S. Cl. CPC G06G 7/16

(57) ABSTRACT

The present disclosure relates to a semiconductor device capable of reducing energy consumption.

Provided is a semiconductor device including: an input unit that inputs a charge; a computing unit that accumulates a charge from the input unit and performs an arithmetic operation; and an output unit that detects and outputs the charge accumulated in the computing unit, in which the computing unit includes an accumulation unit to which a plurality of pair units, each of which is a pair of the input unit and a gate unit, is connected, each of the plurality of pair units makes a charge input from the input unit to the accumulation unit variable, and the accumulation unit accumulates a charge input from each of the connected plurality of pair units. The present disclosure is, for example, applicable to an analog computing device.

### TECHNICAL FIELD

The present disclosure relates to a semiconductor device, and particularly to a semiconductor device capable of reducing energy consumption.

### BACKGROUND ART

In recent years, with the advent of the Internet of Things (IoT) society, it is assumed that an enormous amount of analog signals are subjected to arithmetic processing, and it is expected that analog computation is used for the arithmetic processing. As a technique related to analog computation, for example, a technique disclosed in Patent Document 1 is known. Patent Document 1 proposes a technique for improving a processing speed by causing a plurality of analog computing units to operate in parallel.

### CITATION LIST

### Patent Document

Patent Document 1: Japanese Patent Application Laid-Open No. 4-251390

### SUMMARY OF THE INVENTION

### Problems to be Solved by the Invention

In a case where an analog product-sum operation is performed, it is required to reduce energy consumption.

The present disclosure has been made in view of such a situation, and an object thereof is to reduce energy consumption.

### Solutions to Problems

A semiconductor device according to an aspect of the present disclosure is a semiconductor device including an input unit that inputs a charge; a computing unit that accumulates a charge from the input unit and performs an arithmetic operation; and an output unit that detects and outputs the charge accumulated in the computing unit, in which the computing unit includes an accumulation unit to which a plurality of pair units, each of which is a pair of the input unit and a gate unit, is connected, each of the plurality of pair units makes a charge input from the input unit to the accumulation unit variable, and the accumulation unit accumulates a charge input from each of the connected plurality of pair units.

A semiconductor device according to an aspect of the present disclosure is a semiconductor device including an input unit that inputs a charge; a computing unit that accumulates a charge from the input unit and performs an arithmetic operation; and an output unit that detects and outputs the charge accumulated in the computing unit, in which the computing unit includes an accumulation unit to which a plurality of pair units, each of which is a pair of the input unit and a gate unit, is connected, each of the plurality of pair units makes a charge input from the input unit to the accumulation unit variable, and a charge input from each of the connected plurality of pair units is accumulated.

Note that the semiconductor device according to an aspect of the present disclosure may be an independent device or may be an internal block constituting one device.

### BRIEF DESCRIPTION OF DRAWINGS

FIG. 1 is a diagram illustrating a configuration example of an analog calculator including a dendrite wiring and an axon wiring.

FIG. 2 is a diagram illustrating a configuration example of an analog computing array in which analog calculators are arranged.

FIG. 3 is a diagram illustrating a concept for solving a problem of the current technology.

FIG. 4 is a diagram illustrating a concept for solving a problem of the current technology.

FIG. 5 is a diagram illustrating a concept of a general synapse element configuration.

FIG. 6 is a diagram illustrating a relationship between a gate voltage and a drain current of a MOS transistor.

FIG. 7 is a circuit diagram illustrating a first example of a configuration of an embodiment of an analog computing device to which the present technology is applied.

FIG. 8 is a diagram illustrating an example of a computation operation in a computing unit of FIG. 7.

FIG. 9 is a diagram illustrating an example of charge transfer from the computing unit to an output unit in FIG. 7.

FIG. 10 is a circuit diagram illustrating a second example of a configuration of an embodiment of an analog computing device to which the present technology is applied.

FIG. 11 is a diagram illustrating an example of a computation operation in a computing unit of FIG. 10.

FIG. 12 is a diagram illustrating an example of charge transfer from the computing unit to an output unit in FIG. 10.

FIG. 13 is a diagram illustrating an example of a structure of an input unit, the computing unit, and the output unit.

FIG. 14 is a diagram illustrating an example of a structure of the input unit, the computing unit, and the output unit.

FIG. 15 is a diagram illustrating an example of accumulation of charges due to charge coupling.

FIG. 16 is a diagram illustrating an example of detection of charges due to charge coupling.

FIG. 17 is a diagram illustrating an example of an analog computing method by charge accumulation and transfer.

FIG. 18 is a circuit diagram illustrating a first example of a configuration of the input unit and the computing unit.

FIG. 19 is a cross-sectional view illustrating a first example of a configuration of the input unit and the computing unit.

FIG. 20 is a cross-sectional view illustrating a second example of a configuration of the input unit and the computing unit.

FIG. 21 is a circuit diagram illustrating a third example of a configuration of the input unit and the computing unit.

FIG. 22 is a cross-sectional view illustrating a third example of a configuration of the input unit and the computing unit.

FIG. 23 is a cross-sectional view illustrating an example of a configuration of an accumulation unit of the computing unit.

FIG. 24 is a cross-sectional view illustrating a first example of a configuration of the output unit.

FIG. 25 is a cross-sectional view illustrating a second example of a configuration of the output unit.

FIG. 26 is a circuit diagram illustrating a configuration of an analog computing array system.

FIG. 27 is a diagram illustrating a configuration of the analog computing array system.

FIG. 28 is a conceptual diagram of a case where the analog computing array system is applied to a neural network.

FIG. 29 is a diagram illustrating an example of a configuration in which the analog computing array system is applied to a neural network.

FIG. 30 is a block diagram illustrating an example of a configuration of an embodiment of a configuration of a semiconductor device to which the present technology is applied.

### MODE FOR CARRYING OUT THE INVENTION

In recent years, with the advent of the IoT society, an enormous amount of analog signals are sensed and subjected to arithmetic processing. Assigning of tasks is rapidly progressing, specifically, sensing signal obtained by sensing is subjected to arithmetic processing at an edge on a terminal side, and necessary information obtained by the arithmetic processing is transmitted to a cloud side. However, in the near future, a concern of reaching a limit of supply of energy consumption is becoming apparent due to an enormous amount of sensing signals and a quantitative increase of arithmetic processing that rapidly increase over the entire society.

Further reduction of the energy consumption of the whole social system is an urgent social demand and also a challenge. In particular, in order to reduce energy consumption on a cloud side, improvement of arithmetic processing capability and increase in efficiency on an edge side are the most important issues, and expectations for improvement of energy efficiency in edge computing are increasing.

Research and development of a calculation method with dramatically high energy efficiency in hardware of arithmetic processing in the AI field are rapidly progressing. In this field, especially analog computing systems have attracted attention. A feature of the analog computing method is a computing method of integrating storage and computation in a memory array represented by a computing memory, and this feature provides a method and a possibility of realizing low energy consumption with extremely high energy efficiency.

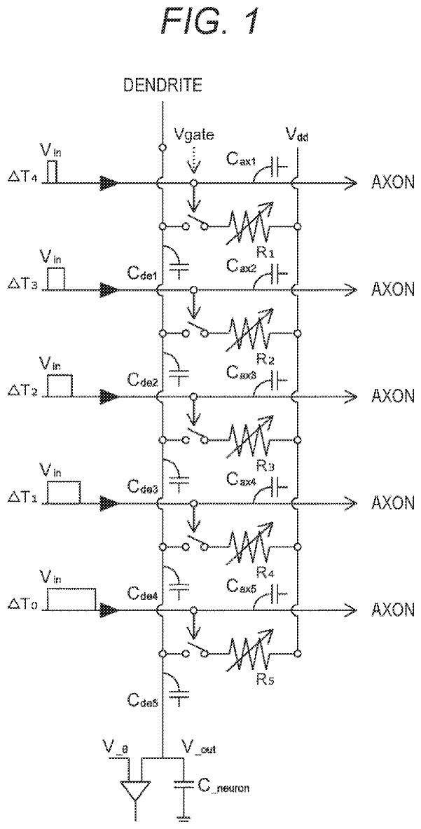

A problem with this type of analog computation is that a limit of energy efficiency of an analog computing method represented by a computing memory has already become apparent. One dominating the limit is charging and discharging of parasitic capacitance of a wiring. FIG. 1 illustrates a configuration example of an analog calculator including a dendrite wiring and an axon wiring.

Here, in a case where a product-sum operation result is output as a voltage Vₒᵤₜ, a relationship of the following expression (1) is established where C_{de} is parasitic capacitance of the dendrite wiring and C_{_neuron} is capacitance of a detector. Note, however, that in the expression (1), C_{dei} represents individual capacitance.

C_{de}=ΣC_{dei}+C_{_neuron} (1)

Therefore, consumed energy E_{_de} of the dendritic wiring has a relationship of the following expression (2).

E_{_de}=(C_{de}+C_{_neuron})×Vₒᵤₜ² (2)

Similarly, consumed energy E_{_ax} of the axon wiring has a relationship of the following expression (3) where Cₐₓ is parasitic capacitance of the axon wiring.

E_{_ax}=(Cₐₓ)×Δt×Vᵢₙ² (3)

As a result, in general, in a case where these analog calculators are arranged and systematized into a large-scale analog computing system, charging and discharging to a total amount of the parasitic capacitance dominate consumed energy and result in dependence on the scale. That is, in the expression (1) described above, a relationship of ΣC_{dei} (individual integrator capacitance)>>C_{_neuron} is established, and a relationship of C_{de}≈ΣC_{dei} is established.

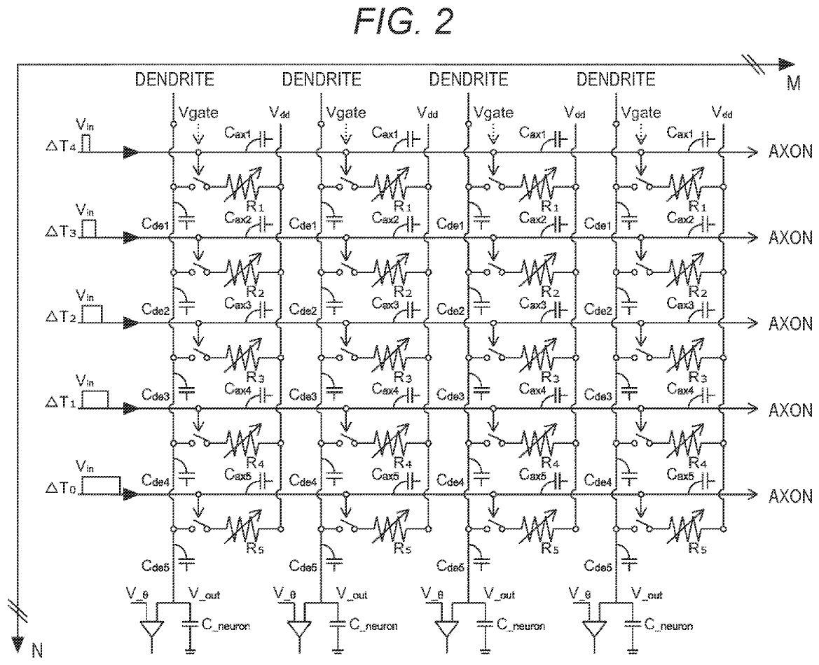

Therefore, in an extension of the current technology, it is difficult in principle to significantly reduce the parasitic capacitance. Moreover, as illustrated in FIG. 2, as scale of a computing array (N rows×M columns) increases, a total amount (N number×C_{de}) of the parasitic capacitance C_{de} also increases in the dendrite wiring, and as a result, consumed energy also increases. Furthermore, as illustrated in FIG. 2, also in the axon wiring, a total amount (M number×Cₐₓ) of the parasitic capacitances Cₐₓ also depends on the scale of the computing array, and as a result, the consumed energy also increases.

Therefore, as a method for reducing the energy consumption of the analog computing system, an analog system that reduces parasitic capacitance of a wiring or lowers an operating voltage is expected. An object of the present disclosure is to reduce consumed energy wasted by parasitic capacitances parasitic in wirings of these analog computing systems and to reduce consumed energy of the entire analog computing system.

A problem to be solved by the present disclosure is reduction of energy consumed by charging and discharging to parasitic capacitance of a dendrite. In general analog calculation intended here, a result of product-sum operation is output as a charge charged to capacitance C_{de} (ΣC_{dei}+C_{_neuron}) of a detection neuron including parasitic capacitance, and a time it takes for the charge to reach a voltage V_{θ} is detected. The consumed energy E_{_de} here is expressed by the following expression (4).

E_{_de}=(C_{de}+C_{_neuron})×V_{θ}² (4)

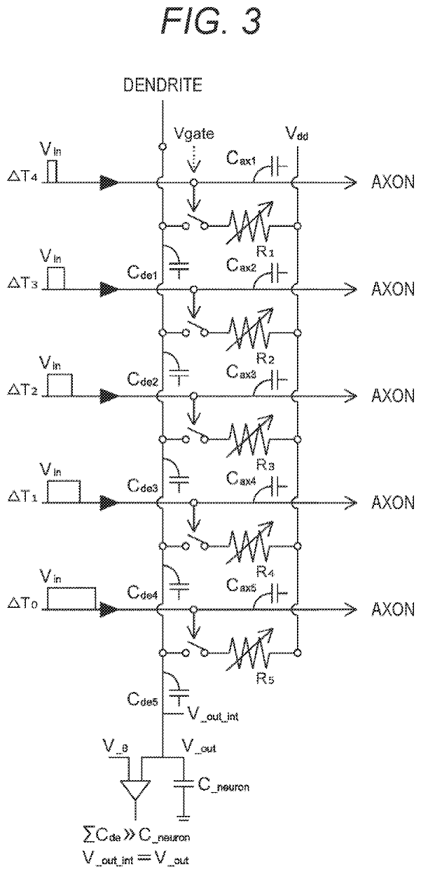

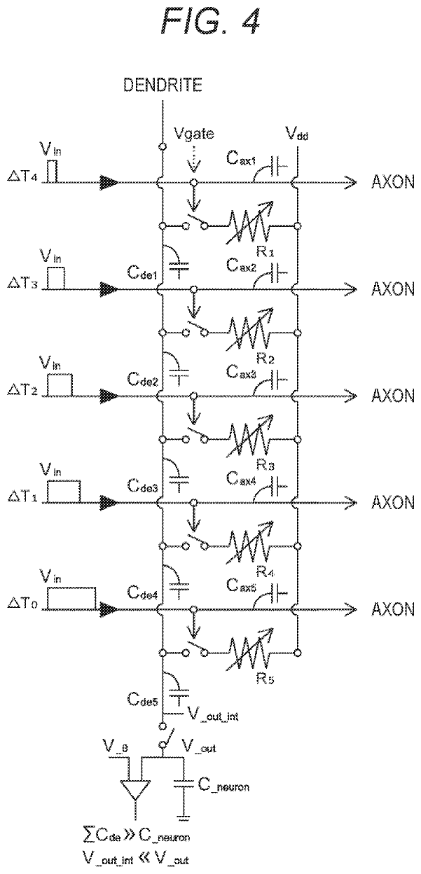

The present disclosure proposes a solution method for such a computing method in which consumed energy depends on C_{de}+C_{_neuron}, in particular, a computing method in which consumed energy depends on parasitic capacitance from the relationship of ΣC_{dei}>>C_{_neuron} in a case where C_{de}=ΣC_{dei}. That is, FIG. 3 illustrates a configuration of the current technology, and FIG. 4 illustrates a configuration of a concept for solving the problem of the current technology. In a case where the relationship ΣC_{dei}>>C_{_neuron} is established, a relationship of V_{_out_int}=V_{_out} is established in the configuration of FIG. 3, whereas a relationship of V_{_out_int}<<V_{_out}, is established in the configuration of FIG. 4.

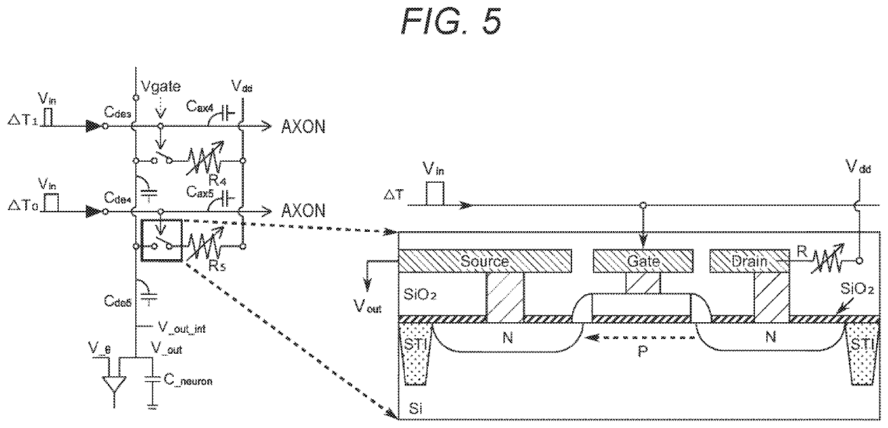

Note that there is also a problem of reduction in voltage of an axon wiring. Intended here is a method in which a pulse signal (time information of ΔT) is input to a gate voltage of a transistor which is generally widely used as a connection/disconnection switch function. FIG. 5 illustrates a conceptual diagram of a general synapse element configuration. The synapse element configuration of FIG. 5 includes a variable resistance element and a switch element.

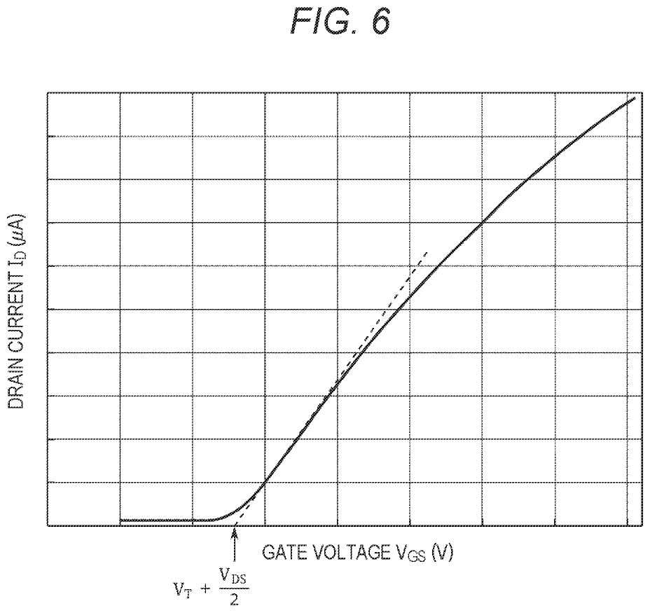

Here, as illustrated in FIG. 6, in a general silicon transistor, focusing on a relationship between a gate voltage V_{GS} and a drain voltage I_{D}, there is a threshold voltage Vth, that is, a threshold voltage at which a drain current does not flow through the gate voltage. Therefore, in principle, a voltage higher than the threshold voltage is required, and this dissipates energy as charging and discharging to parasitic capacitance of an axon wiring of an analog computing array system.

As described above, the technology according to the present disclosure (the present technology) proposes a technology capable of solving the above problems and reducing energy consumption when analog product-sum operation is performed. Hereinafter, embodiments of the present technology will be described with reference to the drawings.

### 1. First Embodiment

(System Configuration)

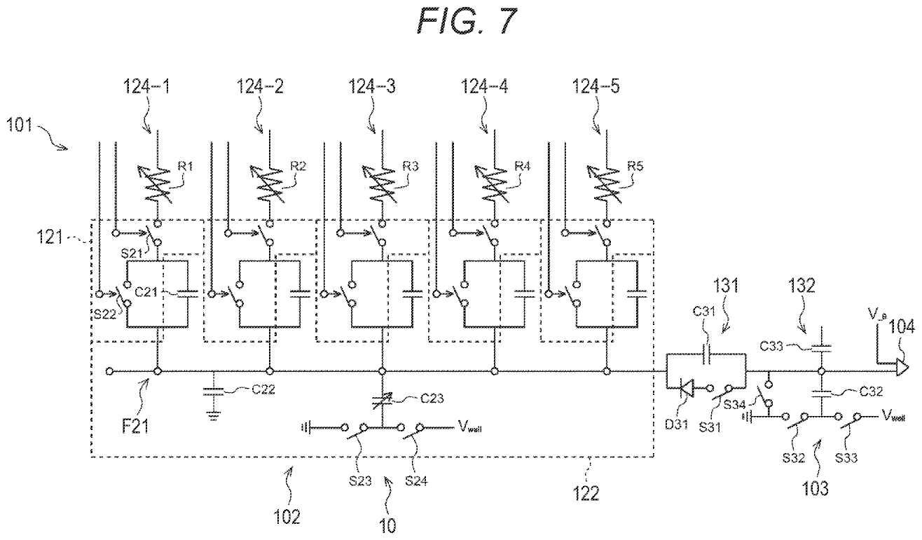

FIG. 7 is a circuit diagram illustrating a first example of a configuration of an embodiment of an analog computing device to which the present technology is applied.

The analog computing device 10 is an analog computing system capable of accumulating input charges and performing computation. The analog computing device 10 includes an input unit 101, a computing unit 102, an output unit 103, and a comparison unit 104.

The input unit 101 includes a variable resistor R1 as a resistance element. In the input unit 101, a charge input by the variable resistor R1 is set. Note that the input unit 101 may include a nonvolatile memory element that can make a resistance value variable.

The computing unit 102 includes a gate unit 121 and an accumulation unit 122. A plurality of pairs of the input unit 101 and the gate unit 121 is connected to the accumulation unit 122 of the computing unit 102. Hereinafter, the pairs of the input unit 101 and the gate unit 121 are also referred to as pair units 124. In FIG. 7, the pair units 124-1 to 124-5 are connected to the accumulation unit 122.

The gate unit 121 includes switches S21 and S22. The gate unit 121 electrically switches connection and disconnection between the input unit 101 and the accumulation unit 122. For example, the gate unit 121 sets a time during which a charge is input by an electric field generated according to a time ΔT of voltage application to a gate electrode unit 121A paired with the gate unit 121. Therefore, in each of the pair units 124-1 to 124-5, a charge input to the accumulation unit 122 is made variable, and a charge obtained as a result is input to the accumulation unit 122 as a result of integration computation.

The accumulation unit 122 includes switches S23 and S24 and capacitors C21, C22, and C23. Furthermore, the accumulation unit 122 has a floating region F21 that is not electrically in contact with an outside of the system. A charge input from each of the connected pair units 124-1 to 124-5 is accumulated in the accumulation unit 122. That is, the pair units 124-1 to 124-5 connected in parallel to the one accumulation unit 122 accumulate (cumulate) charges according to obtained results of integration computation in the common accumulation unit 122, thereby realizing addition operation. In this manner, in the analog computing device 10, product-sum operation of adding results of integration operation is realized.

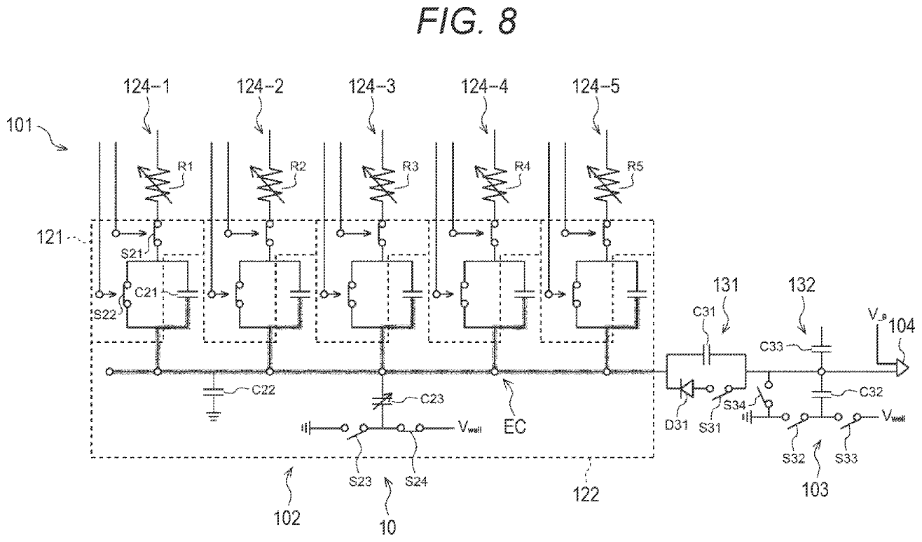

A specific example of computing operation in the computing unit 102 is as illustrated in FIG. 8. In FIG. 8, in the computing unit 102, when the switches S21, S22, and S24 are turned on, charges from the pair units 124-1 to 124-5 are accumulated in the accumulation unit 122 (EC in FIG. 8). As described above, in the accumulation unit 122, product-sum operation is performed by adding results of the integration operation by the pair units 124-1 to 124-5.

See FIG. 7 again. The output unit 103 includes an output gate unit 131 and a detection unit 132. The output gate unit 131 includes a diode D31, a switch S31, and a capacitor C31. The output gate unit 131 inputs (transfers) the charge from the computing unit 102 to the output unit 103 by electrically switching connection and disconnection with (the accumulation unit 122 of) the computing unit 102.

The detection unit 132 includes switches S32, S33, and S34 and capacitors C32 and C33. The detection unit 132 extracts a charge from the computing unit 102 via the output gate unit 131 and detects the charge.

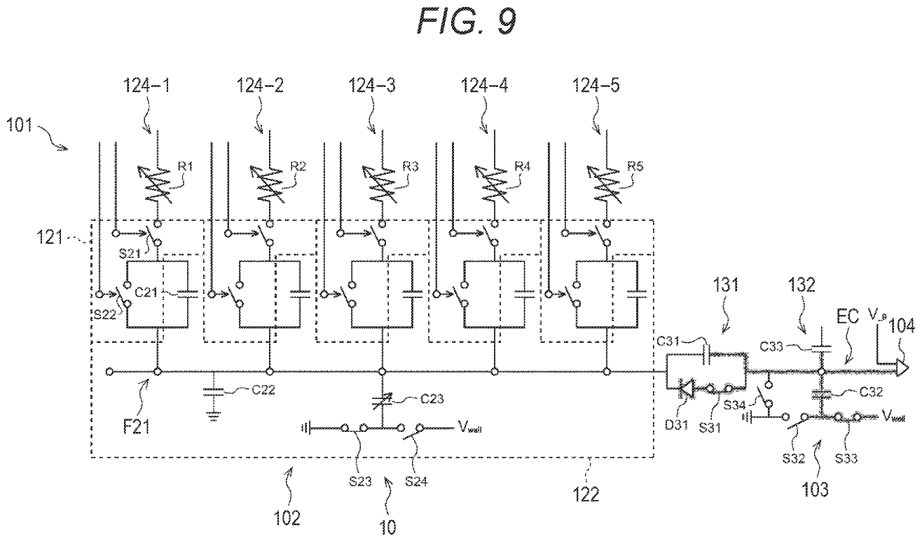

Charge transfer in the computing unit 102 and the output unit 103 is specifically illustrated, for example, in FIG. 9. In FIG. 9, when the switch S23 is turned on and the switches S21, S22, and S24 are turned off in the computing unit 102, and the switches S31 and S33 are turned on in the output unit 103, a charge is transferred from the accumulation unit 122 of the computing unit 102 to the output unit 103 and accumulated (EC in FIG. 9). As described above, the charge is transferred from the computing unit 102 to the output unit 103, and thereby the charge accumulated in the accumulation unit 122 is detected.

See FIG. 7 again. The comparison unit 104 includes a comparator. The comparison unit 104 compares a voltage according to the charge from (the detection unit 132 of) the output unit 103 with a threshold voltage Vθ, and outputs a signal (signal of time) according to the comparison result. For example, in a case where the analog computing device 10 is used for product-sum operation in a neuromorphic device, a signal of time can be output as an output thereof. Note that although FIG. 7 illustrates a case where the comparison unit 104 is provided in a stage following the output unit 103 and a signal of time is output, an output format of the signal output from the output unit 103 is not limited to this.

As described above, the analog computing device 10 of FIG. 7 includes the input unit 101 that inputs a charge, the computing unit 102 that accumulates the charge from the input unit 101 and performs computation, and the output unit 103 that detects and outputs the charge accumulated in the computing unit 102. Furthermore, the computing unit 102 includes the accumulation unit 122 to which the plurality of pair units 124 which is pairs of the input unit 101 and the gate unit 121, is connected.

Each of the plurality of pair units 124 makes the charge input from the input unit 101 to the accumulation unit 122 variable, and the accumulation unit 122 accumulates the charge input from each of the plurality of connected pair units 124. Moreover, the accumulation unit 122 of the computing unit 102 has the floating region F21 that is not electrically in contact with the outside. The floating region F21 makes it possible to accumulate a charge in the accumulation unit 122 and to detect the accumulated charge. In the analog computing device 10 of FIG. 7, product-sum operation is realized in which the accumulation unit 122 adds results of integration operation by the plurality of pair units 124.

### 2. Second Embodiment

(System Configuration)

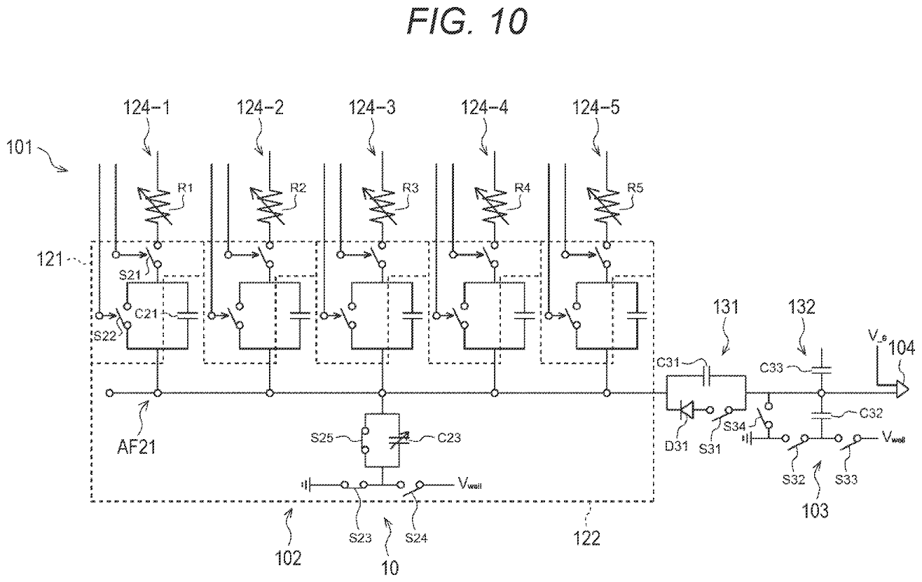

FIG. 10 is a circuit diagram illustrating a second example of a configuration of an embodiment of an analog computing device to which the present technology is applied.

In the circuit diagram of FIG. 10, parts corresponding to those in the circuit diagram of FIG. 7 are given same reference signs, and description thereof will be omitted as appropriate.

In FIG. 10, a computing unit 102 includes a gate unit 121 and an accumulation unit 122. In the computing unit 102, pair units 124-1 to 124-5 are connected to the accumulation unit 122. The accumulation unit 122 includes a charge accumulation region forming unit AF21 in which a region capable of accumulating a charge by an electric field from an outside is formed.

The accumulation unit 122 further includes a switch S25 in addition to capacitors C21 and C23 and switches S23 and S24. In the accumulation unit 122, a floating state is formed in the charge accumulation region forming unit AF21 by generation of an electric field from the outside, and thereby a charge becomes accumulable.

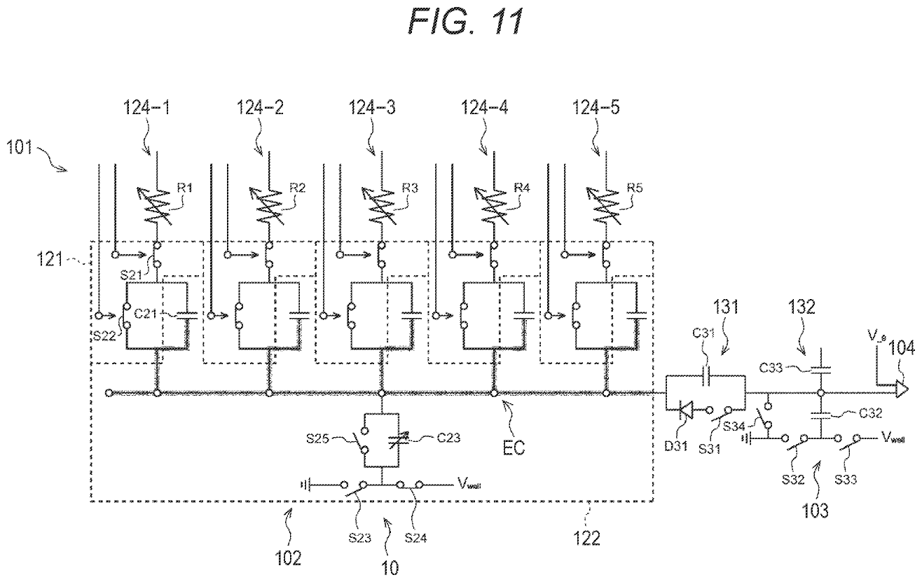

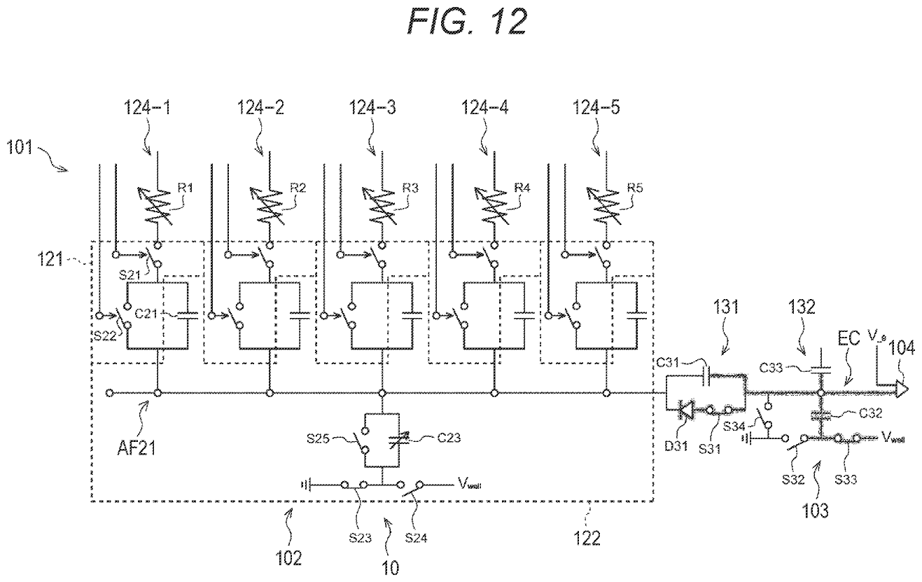

Computation operation and charge transfer in the computing unit 102 is specifically illustrated, for example, in FIGS. 11 and 12.

In FIG. 11, when the switches S21, S22, and S24 are turned on and the switches S23 and S25 are turned off, the state of the computing unit 102 transitions from a ground state illustrated in FIG. 10 to a charge accumulable state. That is, in the accumulation unit 122, a floating state is formed in the charge accumulation region forming unit AF21 by an electric field from the outside, and a charge becomes accumulable, and thereby charges from the pair units 124-1 to 124-5 are accumulated (EC in FIG. 11).

In FIG. 12, when the switch S23 is turned on and the switches S21, S22, and S24 are turned off in the computing unit 102, and the switches S31 and S33 are turned on in the output unit 103, a charge is transferred from the accumulation unit 122 of the computing unit 102 to the output unit 103 and accumulated (EC in FIG. 12). As described above, the charge is transferred from the computing unit 102 to the output unit 103, and thereby the charge accumulated in the accumulation unit 122 is detected.

As described above, the analog computing device 10 of FIG. 10 includes the input unit 101 that inputs a charge, the computing unit 102 that accumulates the charge from the input unit 101 and performs computation, and the output unit 103 that detects and outputs the charge accumulated in the computing unit 102. Furthermore, the computing unit 102 includes the accumulation unit 122 to which the plurality of pair units 124 which is pairs of the input unit 101 and the gate unit 121, is connected.

Each of the plurality of pair units 124 makes the charge input from the input unit 101 to the accumulation unit 122 variable, and the accumulation unit 122 accumulates the charge input from each of the plurality of connected pair units 124. Moreover, the accumulation unit 122 of the computing unit 102 includes the charge accumulation region forming unit AF21 in which a region capable of accumulating a charge by an electric field from an outside is formed. The charge accumulation region forming unit AF21 makes it possible to accumulate a charge in the accumulation unit 122 and to detect the accumulated charge. In the analog computing device 10 of FIG. 10, product-sum operation is realized in which the accumulation unit 122 adds results of integration operation by the plurality of pair units 124.

Note that, although a case where the floating region F21 or the charge accumulation region forming unit AF21 is formed in order to realize arithmetic operation and charge transfer in the accumulation unit 122 has been illustrated in the above description, other methods may be used as long as the methods can realize charge accumulation and charge transfer. Furthermore, although the configuration in which five pair units 124 are connected to one accumulation unit 122 in the analog computing device 10 has been illustrated in the above description, the number of pair units 124 connected to the accumulation unit 122 is not limited to five, and is only required to be any plural number.

### 3. Third Embodiment

(Structure of Each Unit)

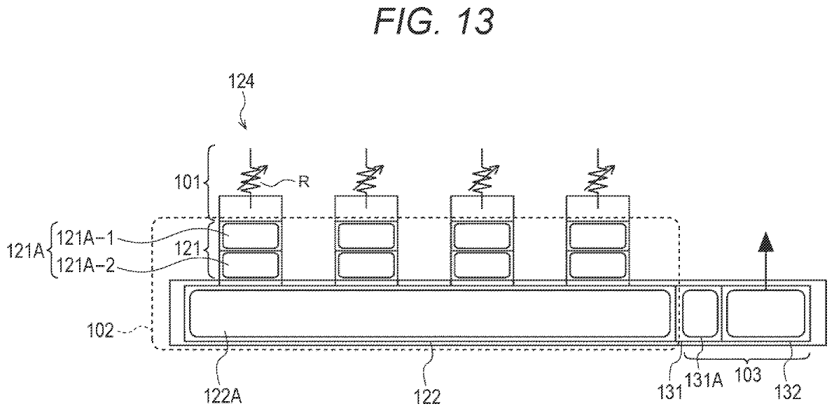

FIG. 13 illustrates an example of a structure of the input unit 101, the computing unit 102, and the output unit 103 in the analog computing device 10 of FIG. 7 or FIG. 10.

In the analog computing device 10, the gate unit 121 of the computing unit 102 electrically separates the input unit 101 from the accumulation unit 122 of the computing unit 102, and has a function of switching connection and disconnection between the input unit 101 and the accumulation unit 122.

In the gate unit 121 and the accumulation unit 122, a gate electrode unit 121A and an accumulation electrode unit 122A are provided in an electrically non-contact state, and are paired with the gate unit 121 and the accumulation unit 122, respectively. Moreover, the gate electrode unit 121A and the accumulation electrode unit 122A are electrically separated from each other. As the gate electrode unit 121A paired with the gate unit 121, a gate electrode unit 121A-1 and a gate electrode unit 121A-2 are provided.

Furthermore, in the analog computing device 10, the output gate unit 131 of the output unit 103 electrically separates the accumulation unit 122 of the computing unit 102 and the detection unit 132 of the output unit 103 from each other, and has a function of switching connection and disconnection between the accumulation unit 122 and the detection unit 132. An output gate electrode unit 131A is provided in the output gate unit 131 in an electrically non-contact state, and is paired with the output gate unit 131. The gate electrode unit 121A, the accumulation electrode unit 122A, and the output gate electrode unit 131A are electrically separated from each other.

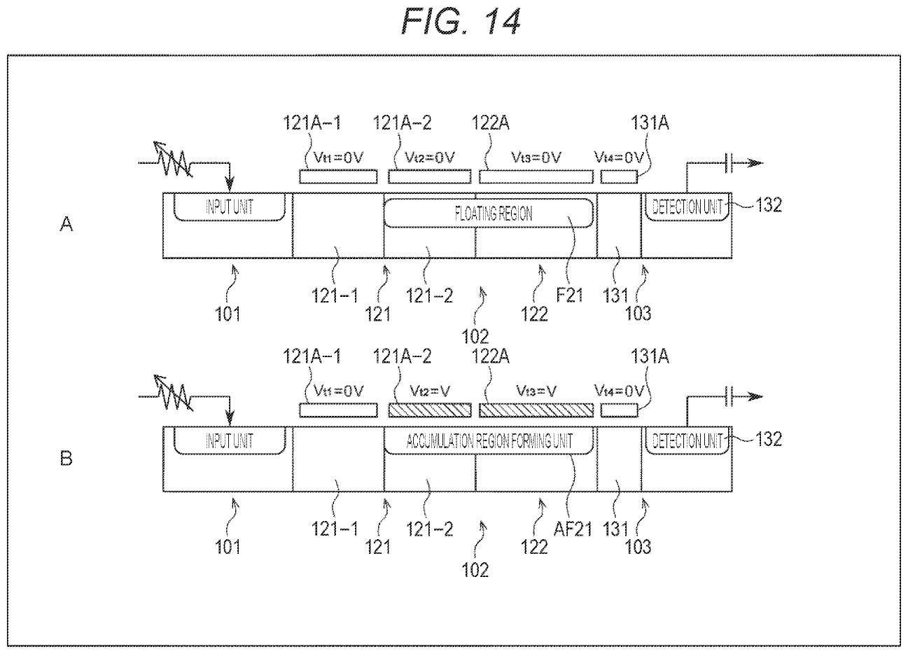

A of FIG. 14 illustrates an example of a structure of the analog computing device 10 of FIG. 7. In A of FIG. 14, the gate electrode units 121A-1 and 121A-2, the accumulation electrode unit 122A, and the output gate electrode unit 131A are paired with gate units 121-1 and 121-2 and the accumulation unit 122 of the computing unit 102, and the output gate unit 131 of the output unit 103, respectively, in an electrically non-contact state.

The gate electrode unit 121A-1, the gate electrode unit 121A-2, the accumulation electrode unit 122A, and the output gate electrode unit 131A are electrically separated from each other, and by individually applying voltages to these units, it is possible to give influence of an electric field to the gate unit 121-1, the gate unit 121-2, the accumulation unit 122, and the output gate unit 131 that are paired with these units.

In A of FIG. 14, a floating region F21 is formed in the gate unit 121-2 and the accumulation unit 122, and by individually controlling voltages Vt1 to Vt4 to the respective electrode units, the floating region F21 can be used as a region (accumulation region) for accumulating charges due to a structure of charge coupling.

B of FIG. 14 illustrates an example of a structure of the analog computing device 10 of FIG. 10. In B of FIG. 14, corresponding electrode units are paired with the gate unit 121-1, the gate unit 121-2, the accumulation unit 122, and the output gate unit 131 in an electrically non-contact state, as in A of FIG. 14.

In B of FIG. 14, a charge accumulation region forming unit AF21 is formed in the gate unit 121-2 and the accumulation unit 122, and an electric field is generated in the gate unit 121-2 and the accumulation unit 122 by applying a voltage Vt2 and a voltage Vt3, which are V, to the gate electrode unit 121A-2 and the accumulation electrode unit 122A, respectively. Therefore, a floating state is formed in the charge accumulation region forming unit AF21, and a charge can be accumulated.

(Charge Accumulation Using Charge Coupling)

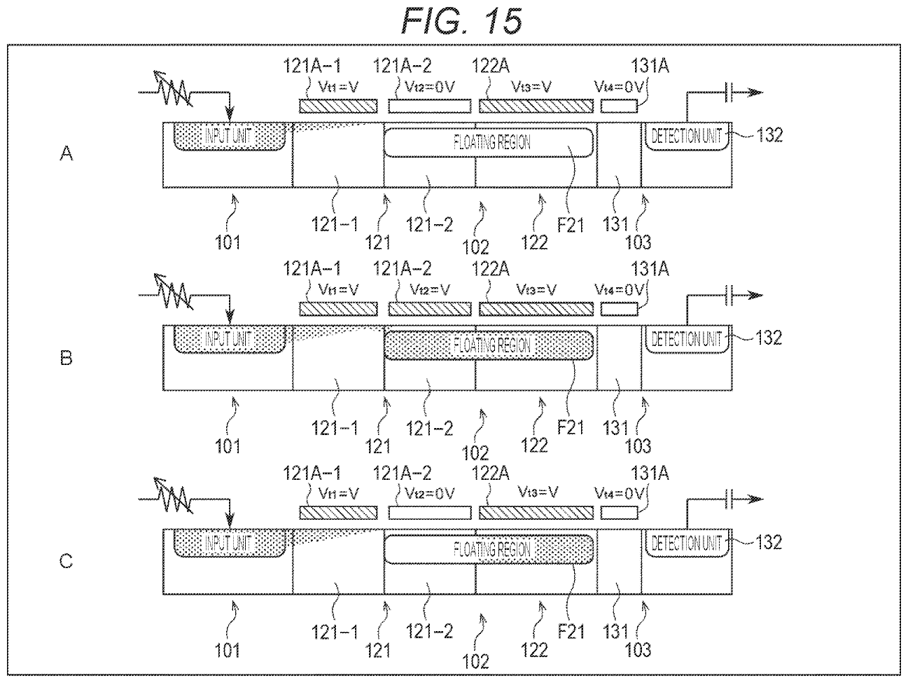

FIG. 15 illustrates an example in which, in the structure illustrated in A of FIG. 14, an operation of individually applying a voltage and an operation of cutting the voltage are performed on each electrode unit, and a charge is accumulated by using charge coupling.

In A of FIG. 15, the voltage Vt1 and the voltage Vt3, which are V, are applied to the gate electrode unit 121A-1 and the accumulation electrode unit 122A, respectively. Subsequently, in B of FIG. 15, by applying the voltage Vt2, which is V, also to the gate electrode unit 121A-2, a charge from the input unit 101 is input to the floating region F21 via the gate unit 121. Thereafter, in C of FIG. 15, by cutting off the voltage applied to the gate electrode unit 121A-2 and setting the voltage Vt2 from V to 0, the charge from the input unit 101 is accumulated in the floating region F21 of the accumulation unit 122.

As described above, in the computing unit 102, by the operation of individually applying the voltage to the gate electrode unit 121A-1, the gate electrode unit 121A-2, and the accumulation electrode unit 122A and the operation of cutting off the voltage, an electric field can be generated and eliminated in the gate unit 121-1, the gate unit 121-2, and the accumulation unit 122 paired with these units. By such an operation, in the computing unit 102, charges from a plurality of pair units 124 (pairs of the input unit 101 and the gate unit 121) can be simultaneously or sequentially input and accumulated (cumulated) in the floating region F21 of the accumulation unit 122.

(Charge Detection Using Charge Coupling)

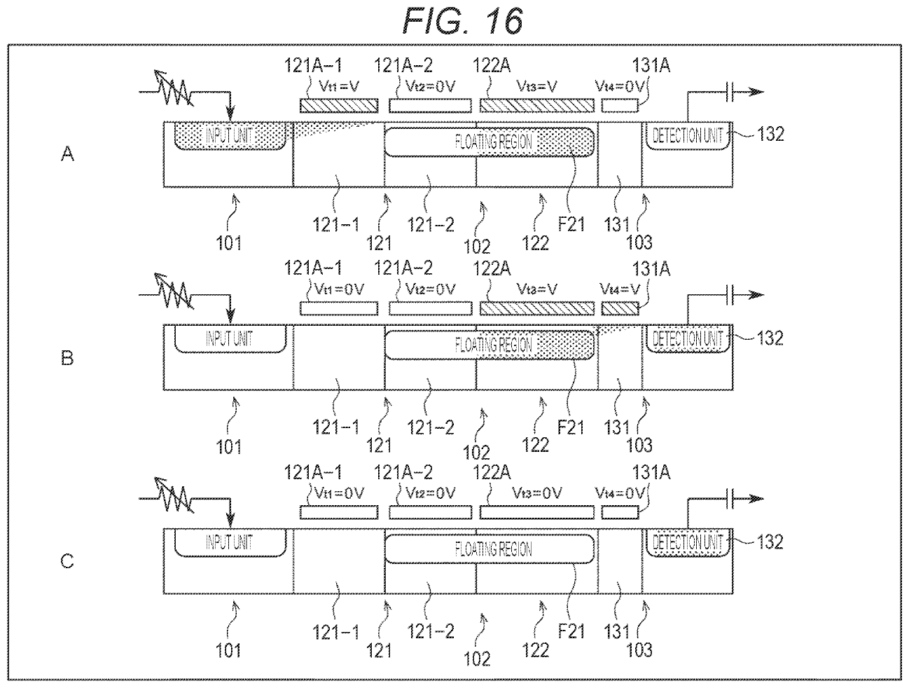

FIG. 16 illustrates an example in which, in the structure illustrated in A of FIG. 14, an operation of individually applying a voltage and an operation of cutting the voltage are performed on each electrode unit, and a charge is detected by using charge coupling.

In A of FIG. 16, the voltage Vt1 and the voltage Vt3, which are V, are respectively applied to the gate electrode unit 121A-1 and the accumulation electrode unit 122A, and charges from the plurality of pair units 124 are accumulated in the floating region F21 of the accumulation unit 122. That is, the state in A of FIG. 16 corresponds to the state in C of FIG. 15.

Thereafter, in B of FIG. 16, by cutting off the voltage Vt1 applied to the gate electrode unit 121A-1 and applying the voltage Vt4, which is V, to the output gate electrode unit 131A, the charges accumulated in the floating region F21 of the accumulation unit 122 are transferred to the detection unit 132 of the output unit 103. Subsequently, in C of FIG. 16, by cutting off the voltage Vt3 and the voltage Vt4 applied to the accumulation electrode unit 122A and the output gate electrode unit 131A, the charges accumulated in the accumulation unit 122 are transferred to and accumulated in the output unit 103, and thereby the charges are detected by the detection unit 132.

As described above, in the computing unit 102 and the output unit 103, by the operation of individually applying the voltage to the gate electrode unit 121A-1, the gate electrode unit 121A-2, the accumulation electrode unit 122A, and the output gate electrode unit 131A and the operation of cutting off the voltage, an electric field can be generated and eliminated in the gate unit 121-1, the gate unit 121-2, the accumulation unit 122, and the output gate unit 131 paired with these units. By such an operation, the charges transferred from the accumulation unit 122 of the computing unit 102 via the output gate unit 131 can be accumulated in the output unit 103 and detected by the detection unit 132.

As described above, in the analog computing device 10, the gate unit 121 and the accumulation unit 122 that constitute the computing unit 102 has a semiconductor layer, and by applying the voltage to the gate electrode unit 121A-2 or the accumulation electrode unit 122A, the floating region F21 in the gate unit 121-2 and the accumulation unit 122 is used by an electric field generated in the paired gate unit 121-2 or accumulation unit 122.

Note that although the structure corresponding to A of FIG. 14 is illustrated in FIGS. 15 and 16, the above description is also applicable to the structure corresponding to B of FIG. 14. That is, in the structure corresponding to B of FIG. 14, by individually applying voltages to the gate electrode unit 121A-2 and the accumulation electrode unit 122A, an electric field is generated in the gate unit 121-2 and the accumulation unit 122, and therefore a floating state is formed in the charge accumulation region forming unit AF21 so that a charge can be accumulated. That is, the gate unit 121-2 includes the floating region F21 or the charge accumulation region forming unit AF21, and is connected to the floating region F21 or the charge accumulation region forming unit AF21 included in the accumulation unit 122.

### 4. Fourth Embodiment

(Analog Computing Method)

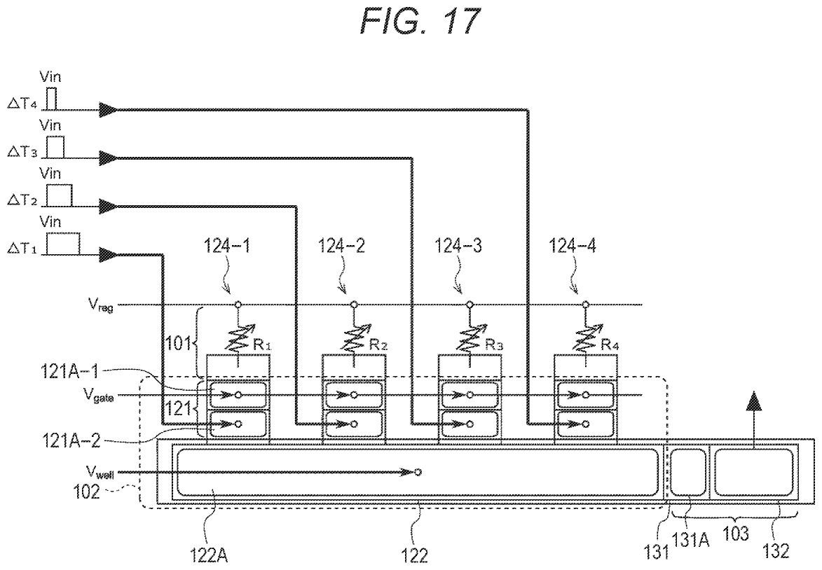

FIG. 17 illustrates an example of an analog computing method using charge accumulation and transfer in the analog computing device 10 of FIG. 7 or 10.

In FIG. 17, as an example of the plurality of pair units 124, pair units 124-1 to 124-4 are connected to the accumulation unit 122 of the computing unit 102. In the pair units 124-1 to 124-4, a variable resistor R is connected as a resistance element to each of the input units 101. In each of the pair units 124, in the gate unit 121 paired with the input unit 101, a voltage Vᵢₙ determined according to a time (voltage application time ΔT) from electrical connection to disconnection between the input unit 101 and the accumulation unit 122 is applied to the paired gate electrode unit 121A-2.

For example, in the pair unit 124-1, a variable resistor R₁ is connected to the input unit 101, and a voltage Vᵢₙ determined according to a voltage application time ΔT₁ is input to the gate electrode unit 121A-2. Similarly, in the pair units 124-2 to 124-4, variable resistors R₂ to R₄ are connected to the respective input units 101, and voltages Vᵢₙ determined according to voltage application times ΔT₂ to ΔT₄ are input to the respective gate electrode units 121A-2.

The accumulation unit 122 accumulates charges input from the input units 101 of the pair units 124-1 to 124-4 according to the voltages Vᵢₙ applied to the gate electrode units 121A-2 of the pair units 124-1 to 124-4 connected to the accumulation unit 122. That is, all charges flowing in from all the input units 101 are accumulated by the voltages Vᵢₙ input to all the gate electrode units 121A-2. Then, after the input of the charges from the pair units 124-1 to 124-4 to the accumulation unit 122 is completed, the charges accumulated in the accumulation unit 122 are transferred to the detection unit 132 via the output gate unit 131 and is detected in the output unit 103. In the detection unit 132, the transferred charges are converted into a voltage and are output.

As described above, in the analog computing device 10, in the computing unit 102, a charge obtained in each of the plurality of pair units 124 is input to the accumulation unit 122 as a result of integration operation, the charge input from each of the plurality of pair units 124 is accumulated in the accumulation unit 122, and all the results of the integration operation are added, and thereby product-sum operation is performed.

### 5. Fifth Embodiment

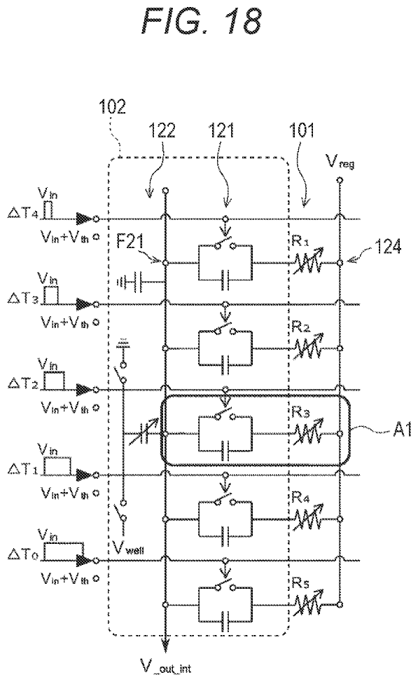

Next, an example of a specific structure of the input unit 101 and the computing unit 102 in the analog computing device 10 will be described with reference to FIGS. 18 to 23.

### First Example

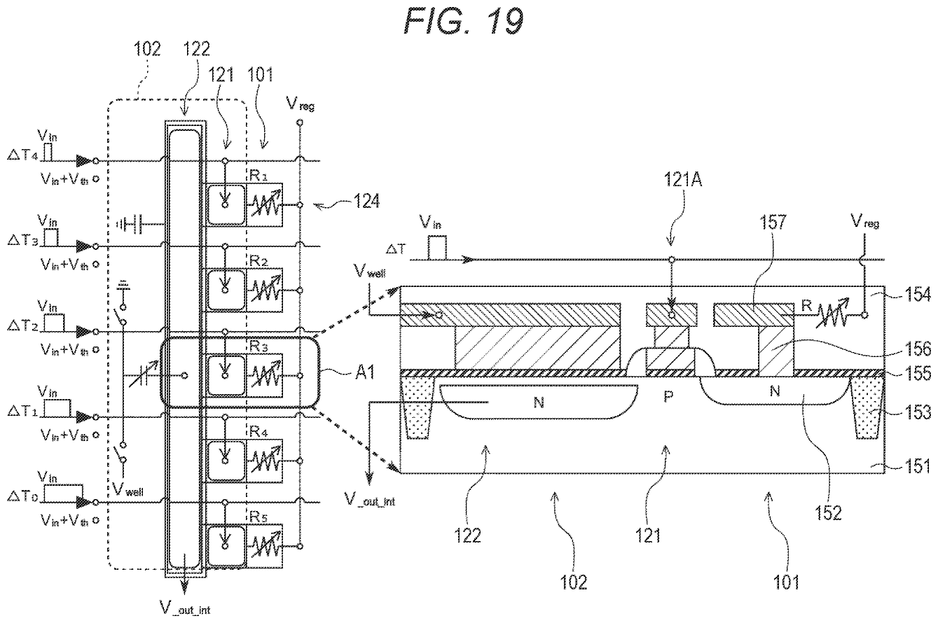

FIG. 18 is a circuit diagram illustrating an example of a configuration of the input unit 101 and the computing unit 102. In FIG. 18, a voltage Vᵢₙ determined according to a voltage application time ΔT is input to the gate unit 121 (the gate electrode unit 121A paired with the gate unit 121) of each of the plurality of pair units 124 connected to the computing unit 102. The circuit diagram in the frame A1 of FIG. 18 corresponds to the frame A1 of FIG. 19, and an example of a cross-sectional view in the frame A1 is illustrated in a place indicated by the broken line.

In the cross-sectional view of FIG. 19, the input unit 101 and the computing unit 102 are provided on a silicon semiconductor substrate. The input unit 101 is in direct contact with and electrically connected to an external electrode, and the gate unit 121 has a structure in which an N-type semiconductor layer 152 of the input unit 101 and an N-type semiconductor layer 152 of the accumulation unit 122 are separated by a P-type semiconductor layer 151. By applying an electric field generated by the gate electrode unit 121A to the P-type semiconductor layer 151, it is possible to switch electrical connection and disconnection between the input unit 101 and the accumulation unit 122 of the computing unit 102.

In the computing unit 102, an input charge is set by the variable resistor R connected to the input unit 101 of the pair unit 124. Furthermore, in order to electrically connect the input unit 101 and the accumulation unit 122 of the computing unit 102, the gate unit 121 of the pair unit 124 sets a time during which a charge is input by an electric field generated according to the voltage application time ΔT by the voltage (Vᵢₙ) applied to the gate electrode unit 121A paired with the gate unit 121. A charge thus obtained is input as a result of integration operation to the accumulation unit 122. Then, the pair units 124 connected in parallel to the common accumulation unit 122 accumulate charges in the common accumulation unit 122, and thereby addition operation of the results of the integration operations is realized. As a result, product-sum operation is realized.

Note that in the cross-sectional view in the frame A1 of FIG. 19, shallow trench isolation (STI) 153 includes an insulator including an oxide and is embedded in a trench for element isolation. Furthermore, a layer in which a polysilicon (Poly-Si) film 156 and a metal film 157 are laminated is provided in an insulating layer 154 such as silicon oxide (SiO₂) above each semiconductor layer. Each semiconductor layer has a structure of sandwiching an insulating film 155 such as silicon oxide (SiO₂) together with each electrode unit.

### Second Example

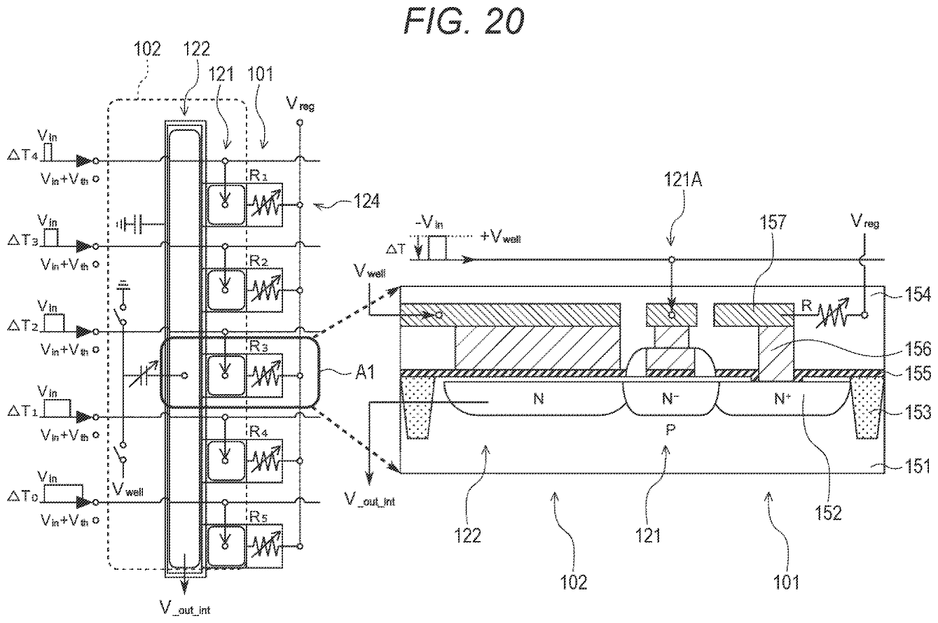

FIG. 20 illustrates another configuration example of the input unit 101 and the computing unit 102. The inside of the frame A1 of FIG. 20 corresponds to the circuit diagram in the frame A1 of FIG. 18, and another example of the cross-sectional view in the frame A1 is illustrated in a place indicated by the broken line.

In the cross-sectional view of FIG. 20, in the input unit 101 and the computing unit 102 provided on the silicon semiconductor substrate, the input unit 101 is in direct contact with and electrically connected to an external electrode. Furthermore, the gate unit 121 includes an N-type semiconductor layer 152, and is in direct contact with an N-type semiconductor layer 152 of the input unit 101 and an N-type semiconductor layer 152 of the accumulation unit 122 of the computing unit 102. By applying a voltage to the gate electrode unit 121A paired with the N-type semiconductor layer 152 of the gate unit 121 and thereby generating an electric field, it is possible to switch electrical connection and disconnection between the input unit 101 and the accumulation unit 122 of the computing unit 102.

In the computing unit 102, an input charge is set by the variable resistor R connected to the input unit 101 of the pair unit 124. Furthermore, in order to electrically connect the input unit 101 and the accumulation unit 122, the gate unit 121 of the pair unit 124 sets a time during which a charge is input by an electric field generated according to the voltage application time ΔT of voltage application to the gate electrode unit 121A paired with the gate unit 121. Therefore, since charges from the pair units 124 are accumulated in the common accumulation unit 122, an addition operation of results of integration operations is performed, and as a result, a product-sum operation is realized.

### Third Example

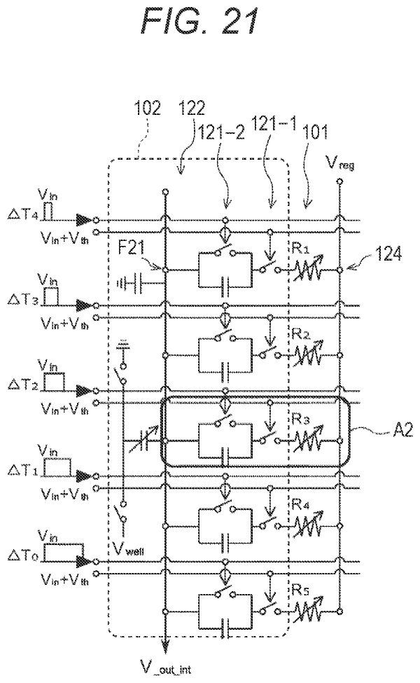

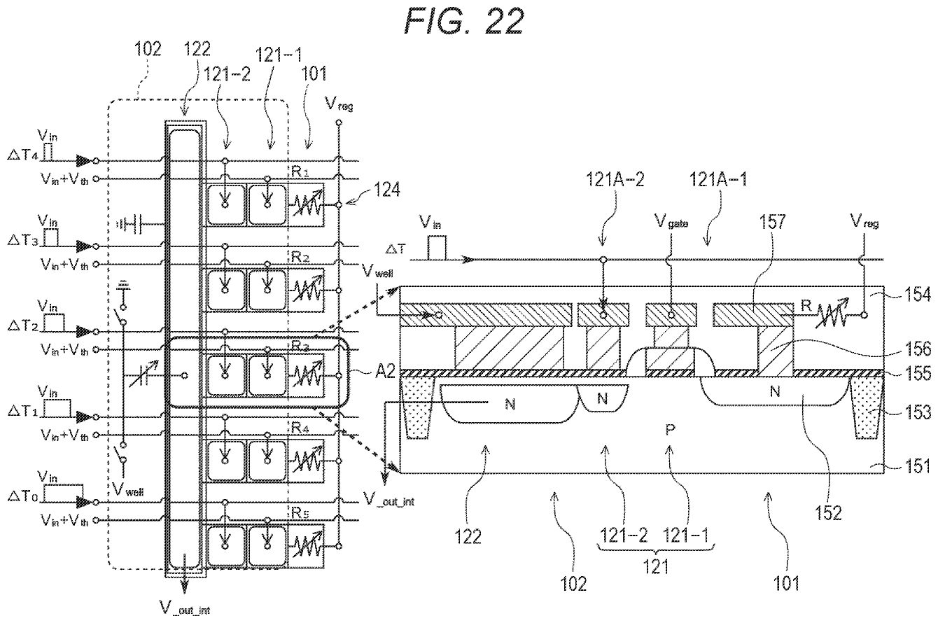

FIG. 21 is a circuit diagram illustrating still another configuration example of the input unit 101 and the computing unit 102. In FIG. 21, a voltage Vᵢₙ determined according to a voltage application time ΔT is input to the gate unit 121 (the gate electrode unit 121A paired with the gate unit 121) of each of the plurality of pair units 124 connected to the computing unit 102. The circuit diagram in the frame A2 of FIG. 21 corresponds to the frame A2 of FIG. 22, and an example of a cross-sectional view in the frame A2 is illustrated in a place indicated by the broken line.

In the cross-sectional view of FIG. 22, in the input unit 101 and the computing unit 102 provided on the silicon semiconductor substrate, the input unit 101 is in direct contact with and electrically connected to an external electrode. The gate unit 121-1 has a structure in which the N-type semiconductor layer 152 of the input unit 101 and the N-type semiconductor layer 152 of the accumulation unit 122 of the computing unit 102 are separated by the P-type semiconductor layer 151. By applying a voltage to the gate electrode unit 121A-1 paired with the P-type semiconductor layer 151 of the gate unit 121-1 and thereby generating an electric field, it is possible to switch electrical connection and disconnection between the input unit 101 and the accumulation unit 122 of the computing unit 102.

Although the gate unit 121-2 includes the N-type semiconductor layer 152, by applying a voltage to the paired gate electrode unit 121A-2 and thereby generating an electric field, it is possible to switch electrical connection and disconnection between the input unit 101 and the accumulation unit 122 of the computing unit 102, as in the case of the gate unit 121-1.

In the computing unit 102, an input charge is set by the variable resistor R connected to the input unit 101 of the pair unit 124. Furthermore, in the gate unit 121 of the pair unit 124, in order to electrically connect the input unit 101 and the accumulation unit 122, electrical connection and disconnection between the input unit 101 and the accumulation unit 122 are switched by application of a voltage to the gate electrode unit 121A-1 paired with the gate unit 121-1. Moreover, the gate unit 121 of the pair unit 124 sets a time during which a charge is input by an electric field generated according to the voltage application time ΔT of voltage application to the gate electrode unit 121A-2 paired with the gate unit 121-2. Therefore, since charges from the pair units 124 are accumulated in the common accumulation unit 122, an addition operation of results of integration operations is performed, and as a result, a product-sum operation is realized.

### Fourth Example

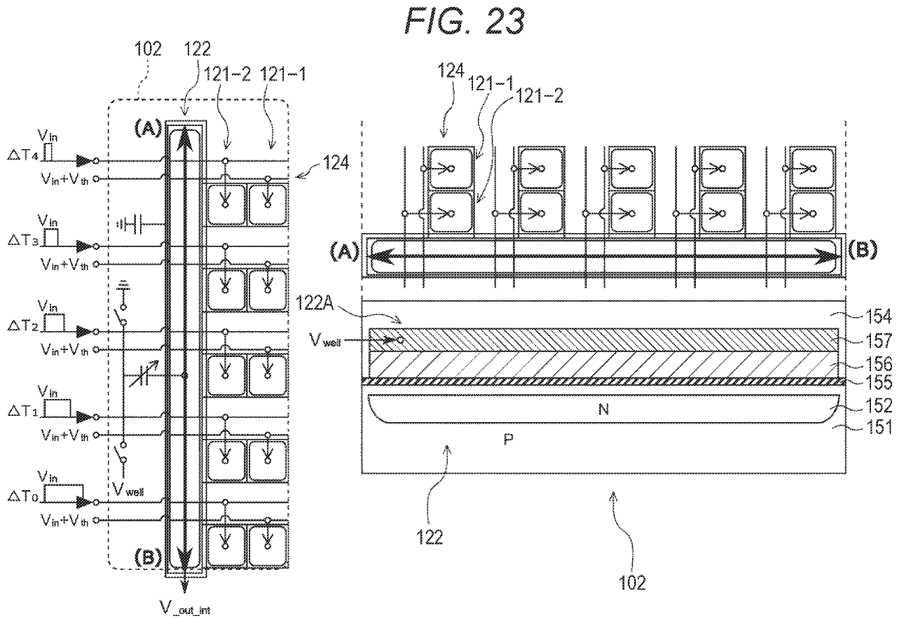

FIG. 23 illustrates another configuration example of the accumulation unit 122 of the computing unit 102. The computing unit 102 within the broken line on the left side of FIG. 23 corresponds to the computing unit 102 (a portion excluding the input unit 101) within the broken line on the left side of FIG. 22. The right side of FIG. 23 illustrates a cross-sectional view taken along (A)-(B) indicated by the bidirectional arrow drawn on the accumulation unit 122 in the computing unit 102 within the broken line on the left side of FIG. 23.

In the cross-sectional view of FIG. 23, the plurality of pair units 124 is connected in parallel to the accumulation unit 122 of the computing unit 102 provided on the silicon semiconductor substrate. The computing unit 102 has a structure in which the N-type semiconductor layer 152 of the accumulation unit 122 is an electrical floating region with respect to the P-type semiconductor layer 151 so that a charge from each pair unit 124 can be accumulated. In the accumulation unit 122, by applying a voltage (V_{well}) to the paired accumulation electrode unit 122A, an addition operation of accumulating results of integration operations from the pair units 124 connected in parallel by an electric field effect is realized as a charge accumulation amount.

### 6. Sixth Embodiment

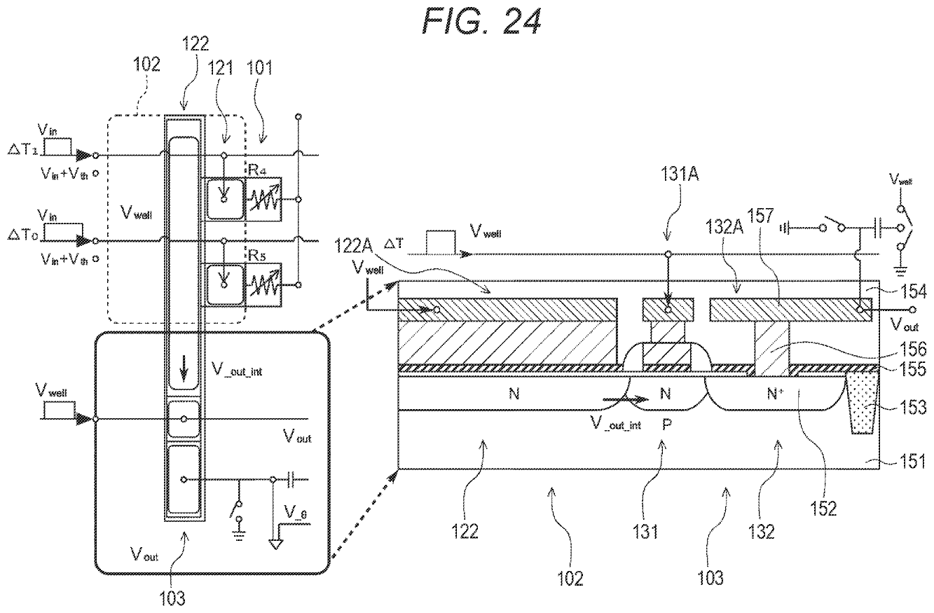

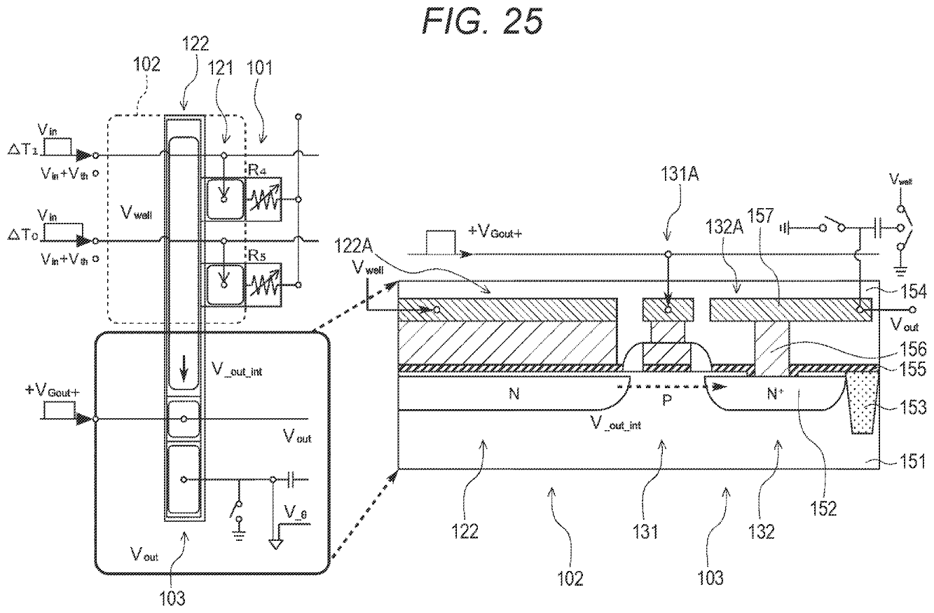

Next, an example of a specific structure of the output unit 103 in the analog computing device 10 will be described with reference to FIGS. 24 and 25.

### First Example

FIG. 24 illustrates an example of the configuration of the output unit 103. The left side of FIG. 24 corresponds to a part of the left side of FIG. 19, and the output unit 103 is illustrated together with the computing unit 102. The right side of FIG. 24 illustrates an example of a cross-sectional view of the output unit 103 within the solid line on the left side of FIG. 24.

In the cross-sectional view of FIG. 24, the computing unit 102 and the output unit 103 are provided on the silicon semiconductor substrate. The output unit 103 includes the output gate unit 131 and the detection unit 132, and the output gate unit 131 is connectable to the accumulation unit 122 of the computing unit 102. After a product-sum operation is completed in the computing unit 102, a charge accumulated (cumulated) in the accumulation unit 122 is transferred to the detection unit 132 via the output gate unit 131.

The output gate unit 131 includes the N-type semiconductor layer 152, and is electrically connected to the N-type semiconductor layer 152 of the accumulation unit 122 and the N-type semiconductor layer 152 of the detection unit 132. As for transfer of the charge accumulated (cumulated) in the accumulation unit 122, an electric field is generated in the N-type semiconductor layer 152 of the output gate unit 131 by applying a voltage (V_{well}) to the paired output gate electrode unit 131A, and the charge is transferred (transported) from the accumulation unit 122 by cutting off the voltage (V_{well}) of the accumulation electrode unit 122A paired with the accumulation unit 122. In this manner, the output gate unit 131 can switch electrical connection and disconnection between the accumulation unit 122 of the computing unit 102 and the detection unit 132 of the output unit 103.

The detection unit 132 has a structure in which the N-type semiconductor layer 152 includes an electrical floating region, and is electrically connected to the N-type semiconductor layer 152 of the output gate unit 131. In the detection unit 132, a voltage is applied to (or cut off from) the paired detection electrode unit 132A in the floating region of the N-type semiconductor layer 152, and thereby the charge from the output gate unit 131 is transferred (transported) by an electric field effect. As a result, the detection unit 132 can receive and detect the charge transferred from the output gate unit 131.

### Second Example

FIG. 25 illustrates another example of the configuration of the output unit 103. In the cross-sectional view of FIG. 25, the output unit 103 provided on the silicon semiconductor substrate includes the output gate unit 131 and the detection unit 132, and the output gate unit 131 is connectable to the accumulation unit 122 of the computing unit 102. After a product-sum operation is completed in the computing unit 102, a charge accumulated (cumulated) in the accumulation unit 122 is transferred to the detection unit 132 via the output gate unit 131.

The output gate unit 131 includes the P-type semiconductor layer 151, and is in contact with the N-type semiconductor layer 152 of the accumulation unit 122 and the N-type semiconductor layer 152 of the detection unit 132. As for transfer of the charge accumulated (cumulated) in the accumulation unit 122, an electric field is generated in the P-type semiconductor layer 151 of the output gate unit 131 by applying a voltage (+V_{Gout+}) to the paired output gate electrode unit 131A, and the charge is transferred (transported) from the accumulation unit 122 by cutting off the voltage (V_{well}) of the accumulation electrode unit 122A paired with the accumulation unit 122. In this manner, the output gate unit 131 can switch electrical connection and disconnection between the accumulation unit 122 of the computing unit 102 and the detection unit 132 of the output unit 103.

The detection unit 132 has a structure in which the N-type semiconductor layer 152 includes an electrical floating region, and is in contact with the P-type semiconductor layer 151 of the output gate unit 131. In the detection unit 132, a voltage is applied to (or cut off from) the paired detection electrode unit 132A in the floating region of the N-type semiconductor layer 152, and thereby the charge from the output gate unit 131 is transferred (transported) by an electric field effect. As a result, the detection unit 132 can receive and detect the charge transferred from the output gate unit 131.

### 7. Seventh Embodiment

(Array System Configuration)

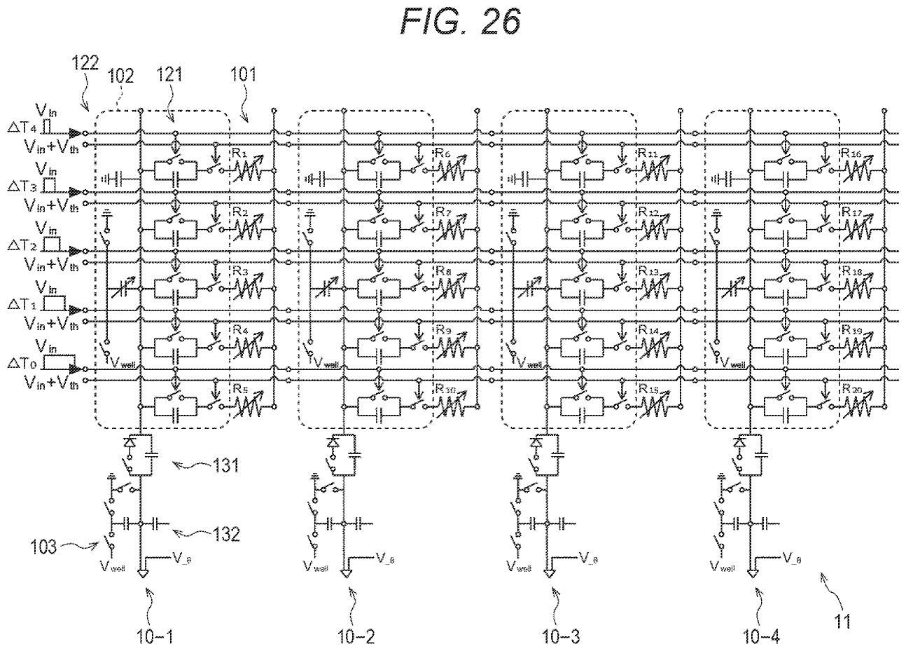

FIG. 26 is a circuit diagram illustrating a configuration of an analog computing array system to which the present technology is applied.

In FIG. 26, an analog computing array system 11 has a configuration in which a plurality of analog computing devices 10 is arranged in an array. In the analog computing array system 11 of FIG. 26, analog computing devices 10-1 to 10-4 are arranged in parallel, and gate electrode units 121A paired with gate units 121 of computing units 102 of the analog computing devices 10-1 to 10-4 are electrically connected to each other.

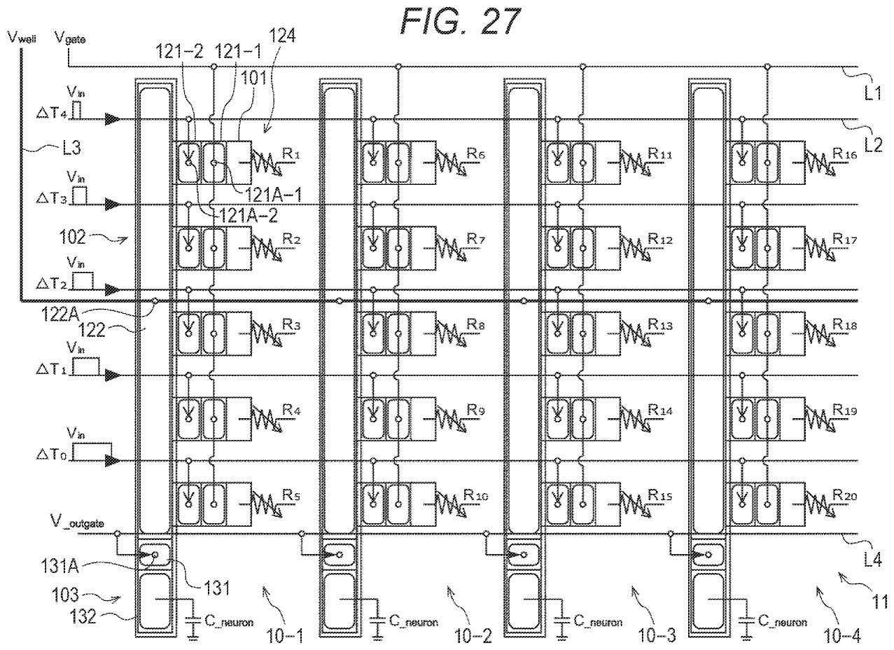

Specifically, as illustrated in FIG. 27, in each of the analog computing devices 10-1 to 10-4, a plurality of pair units 124 is connected to an accumulation unit 122 of the computing unit 102. Each of the pair units 124 includes a pair of input unit 101 and gate unit 121 (121-1,121-2). In the analog computing devices 10-1 to 10-4 arranged in parallel, gate electrode units 121A-1 paired with the gate units 121-1 of the pair units 124 arranged in a lateral direction and a longitudinal direction in the same row and column are electrically connected by a signal line L1. Furthermore, gate electrode units 121A-2 paired with the gate units 121-2 of the pair units 124 arranged in a lateral direction in the same row are electrically connected by a signal line L2.

Therefore, in the analog computing array system 11, by controlling voltages (V_{gate}, Vᵢₙ) applied to the signal lines L1, L2, the gate electrode units 121A-1, 121A-2 connected to the same signal lines L1, L2 can be commonly controlled in the analog computing devices 10-1 to 10-4.

Furthermore, in each of the analog computing devices 10, in the computing unit 102, an accumulation electrode unit 122A paired with the accumulation unit 122 is connected to a signal line L3, and in the output unit 103, an output gate electrode unit 131A paired with an output gate unit 131 is connected to a signal line L4, and the units are controlled by applying voltages (V_{well}, V_{outgate}) to these signal lines L3, L4.

Note that, although the configuration in which the four analog computing devices 10 are arranged in parallel has been illustrated in the analog computing array system 11 in FIGS. 26 and 27, the number of analog computing devices 10 arranged in parallel is not limited to four, and is only required to be any plural number. Furthermore, although the configuration in which the five pair units 124 are connected to the accumulation unit 122 of the computing unit 102 in each of the analog computing devices 10 has been illustrated, the number of pair units 124 is not limited to five, and is only required to be any plural number. Moreover, the example of the configuration of the input unit 101 and the computing unit 102 is not limited to the configuration illustrated in FIGS. 21 and 22, and may be the configuration illustrated in FIGS. 18 and 19.

(Application Example of Neural Network)

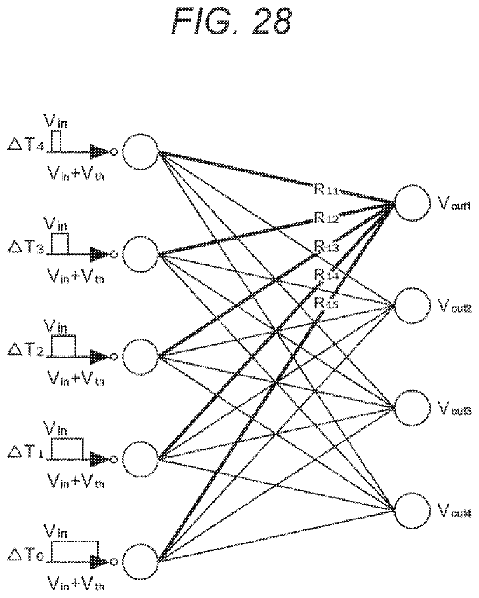

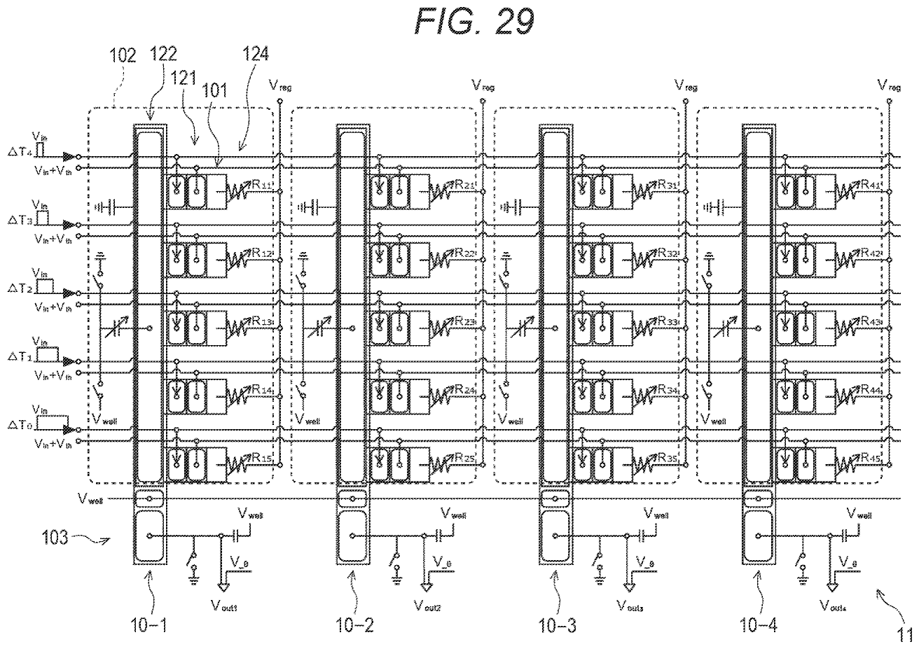

FIGS. 28 and 29 illustrate an example of a configuration in which the analog computing array system 11 is applied to a neural network. The configuration of the analog computing array system 11 in this case can be, for example, a configuration in which the analog computing devices 10 obtained by combining the configuration example of the input unit 101 and the computing unit 102 illustrated in FIGS. 21 and 22 and the configuration example of the computing unit 102 and the output unit 103 illustrated in FIG. 25 are arranged in an array.

FIG. 28 illustrates an example in which a product-sum operation of one intermediate layer in the neural network is realized by the analog computing array system 11. In the analog computing array system 11, the accumulation units 122 to which the plurality of pair units 124 is connected are arranged in parallel. More specifically, as illustrated in FIG. 29, in the analog computing array system 11, the plurality of analog computing devices 10 is arranged in parallel, and an input signal having a pulse width ΔT to be input is connected, by a shared signal line, to the corresponding input unit 101 in the plurality of pair units 124 connected to the computing units 102 arranged in parallel.

With such a configuration, in the analog computing array system 11, input signals having pulse widths ΔT0 to ΔT4 are input to the analog computing devices 10-1 to 10-4, respectively, and a product-sum operation is performed in each of the analog computing devices 10-1 to 10-4. However, in the analog computing device 10-1, resistance elements connected to the input units 101 of the respective pair units 124 are variable resistors R₁₁ to R₁₅. Furthermore, in each of the analog computing devices 10-2, 10-3, and 10-4, resistance elements connected to the input units 101 of the respective pair units 124 are variable resistors R₂₁ to R₂₅, variable resistors R₃₁ to R₃₅, or variable resistors R₄₁ to R₄₅.

The analog computing devices 10-1 to 10-4 output voltages Vₒᵤₜ₁ to Vₒᵤₜ₄ according to results of product-sum operations, respectively. That is, in the analog computing array system 11, output signals (Voltages Vₒᵤₜ₁, Vₒᵤₜ₂, Vₒᵤₜ₃, and Vₒᵤₜ₄) output from the respective analog computing devices 10-1 to 10-4 correspond to results of the product-sum operations for one layer of the neural network.

### 8. Eighth Embodiment

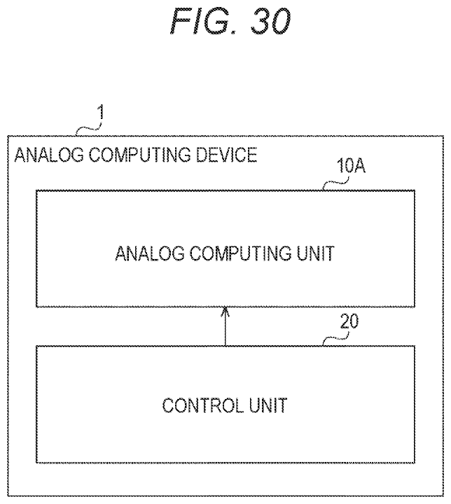

FIG. 30 is a diagram illustrating an example of a configuration of an embodiment of a configuration of a semiconductor device to which the present technology is applied.

An analog computing device 1 is an example of a semiconductor device. The analog computing device 1 includes an analog computing unit 10A and a control unit 20. The analog computing unit 10A has a configuration corresponding to the analog computing device 10 illustrated in FIG. 7 or 10. Furthermore, the analog computing unit 10A may have a configuration corresponding to the analog computing array system 11 illustrated in FIG. 26 and other drawings.

The control unit 20 includes a processor and the like, and controls operation of the analog computing unit 10A. For example, the control unit 20 controls a voltage applied to each electrode unit, for example, during computing operation performed in the analog computing unit 10A.

Note that although FIG. 30 illustrates the configuration in which the control unit 20 is provided inside the analog computing device 1, the control unit 20 may be provided in an external device (not illustrated). In a case where the control unit 20 is provided in the external device, a control signal from (the control unit 20 of) the external device is input to (the analog computing unit 10A of) the analog computing device 1 via a predetermined interface.

As described above, the analog computing device 10 to which the present technology is applied includes the input unit 101, the computing unit 102, and the output unit 103. The computing unit 102 includes the accumulation unit 122 to which the plurality of pair units 124 each including a pair of the input unit 101 and the gate unit 121 is connected. Each of the plurality of pair units 124 makes a charge input from the input unit 101 to the accumulation unit 122 variable, the accumulation unit 122 accumulates the charge input from each of the connected plurality of pair units 124, and thereby an analog product-sum operation is realized. In the analog product-sum operation realized in this way, energy consumption can be reduced as compared with an analog product-sum operation using the current technology.

Here, an analog product-sum operation system has extremely excellent advantages in computing speed and low energy consumption, and a large number of computing methods have been proposed. However, as described above, all crossbar-type analog product-sum operations using a device element is approaching a limit of low energy consumption on an extension of the current technology. One of the largest obstacles to further reduction in energy consumption in an analog product-sum operation is a loss resulting from parasitic capacitance of an analog product-sum unit, which is a major constraint on higher energy efficiency.

The analog computing device 10 to which the present technology is applied includes the input unit 101, the computing unit 102, and the output unit 103. In order to reduce energy consumption resulting from parasitic capacitance of input/output wiring in an analog product-sum operation, (the accumulation unit 122 of) the computing unit 102 accumulates charges in a potential well structure due to an electric field effect and performs accumulation operation, and the accumulated charges are transferred to (the detection unit 132 of) the output unit 103.

As described above, in the analog computing device 10 to which the present technology is applied, a reduction in energy consumption is realized by separating the charge accumulation function of the product-sum operation and the charge detection function. Furthermore, in the analog computing device 10 to which the present technology is applied, an analog product-sum operation using an extremely small amount of charges, which cannot be performed due to parasitic capacitance in the current technology, becomes possible, and accordingly, a voltage of signal input/output wiring is reduced, and a reduction in energy consumption, which is a limit of the current technology, becomes possible. Note that, according to a detailed simulation conducted by the inventors of the present technology, it has been confirmed that the analog computing device 10 to which the present technology is applied has an effect of reducing energy consumption as compared with an analog calculator to which the current technology is applied.

Note that the embodiments of the present technology are not limited to the above embodiments, and various modifications can be made without departing from the gist of the present technology.

In the present specification, a system means a set of a plurality of components (devices, elements, modules (parts), or the like). Furthermore, in the present specification, the “charge” includes the meaning of a charge amount, which is an amount of charge, and the “charge” may be read as the “charge amount”. Furthermore, the effects described in the present specification are merely examples and are not limited, and other effects may be produced.

Note that the present disclosure can have the following configurations.

(1)

A semiconductor device including

an input unit that inputs a charge;

a computing unit that accumulates a charge from the input unit and performs an arithmetic operation; and

an output unit that detects and outputs the charge accumulated in the computing unit,

in which

the computing unit includes an accumulation unit to which a plurality of pair units, each of which is a pair of the input unit and a gate unit, is connected,

each of the plurality of pair units makes a charge input from the input unit to the accumulation unit variable, and

the accumulation unit accumulates charges input from the connected plurality of pair units.

(2)

The semiconductor device according to (1), in which

the computing unit has a floating region that is not electrically in contact with an outside.

(3)

The semiconductor device according to (1), in which

the computing unit includes a charge accumulation region forming unit in which a region where a charge is accumulable by an electric field from an outside is formed.

(4)

The semiconductor device according to any one of (1) to (3), in which

the output unit includes an output gate unit and a detection unit,

the gate unit is electrically separated from the input unit and the accumulation unit and switches connection and disconnection between the input unit and the accumulation unit, and

the output gate unit is electrically separated from the accumulation unit and the detection unit and switches connection and disconnection between the accumulation unit and the detection unit.

(5)

The semiconductor device according to (4), in which

a gate electrode unit and an accumulation electrode unit are paired with the gate unit and the accumulation unit in an electrically non-contact state, respectively, and the gate electrode unit and the accumulation electrode unit are electrically separated.

(6)

The semiconductor device according to (5), in which

an output gate electrode unit is paired with the output gate unit in an electrically non-contact state, and the gate electrode unit, the accumulation electrode unit, and the output gate electrode unit are electrically separated, and

by individually applying a voltage to the gate electrode unit, the accumulation electrode unit, and the output gate electrode unit, influence of an electric field is given to the gate unit, the accumulation unit, and the output gate unit that are paired with the gate electrode unit, the accumulation electrode unit, and the output gate electrode unit, respectively.

(7)

The semiconductor device according to (6), in which

by an operation of individually applying a voltage to the gate electrode unit and the accumulation electrode unit and an operation of cutting off the voltage, an electric field is generated or eliminated in each of the gate unit and the accumulation unit paired with the gate electrode unit and the accumulation electrode unit, and thereby the charge from the input unit is input to the accumulation unit via the gate unit and is accumulated.

(8)

The semiconductor device according to (6), in which

by an operation of individually applying a voltage to the accumulation electrode unit and the output gate electrode unit and an operation of cutting off the voltage, an electric field is generated or eliminated in each of the accumulation unit and the output gate unit paired with the accumulation electrode unit and the output gate electrode unit, and thereby the charge accumulated in the accumulation unit is transferred to the detection unit via the output gate unit and is detected.

(9)

The semiconductor device according to any one of (5) to (8), in which

in each of the plurality of pair units, the input unit includes a resistance element,

in the gate unit paired with the input unit, a voltage determined according to a time from electric connection between the input unit and the accumulation unit to disconnection between the input unit and the accumulation unit is applied to the gate electrode unit paired with the gate unit, and

the accumulation unit accumulates a charge input from the input unit of each of the plurality of pair units according to a voltage applied to the gate electrode unit of each of the connected plurality of pair units.

(10)

The semiconductor device according to (9), in which

a charge obtained in each of the plurality of pair units is input to the accumulation unit as a result of an integration operation,

the charge input from each of the plurality of pair units is accumulated in the accumulation unit, and all results of the integration operations are added, and

thereby, a product-sum operation is performed.

(11)

The semiconductor device according to (9) or (10), in which

in the output unit, the charge accumulated in the accumulation unit is transferred to the detection unit via the output gate unit and is detected after the input of the charge to the accumulation unit is completed.

(12)

The semiconductor device according to any one of (1) to (11), in which

the gate unit includes a floating region that is not electrically in contact with an outside or a charge accumulation region forming unit in which a region where a charge is accumulable by an electric field from an outside is formed.

(13)

The semiconductor device according to (12), in which

the floating region or the charge accumulation region forming unit of the gate unit is connected to a floating region of the accumulation unit.

(14)

The semiconductor device according to (5), in which

the gate unit and the accumulation unit include a semiconductor layer, and

floating regions in the gate unit and the accumulation unit are formed by an electric field generated in the gate unit or the accumulation unit paired with the gate electrode unit or the accumulation electrode unit by applying a voltage to the gate electrode unit or the accumulation electrode unit.

(15)

The semiconductor device according to (4), in which

the output unit includes a semiconductor layer.

(16)

The semiconductor device according to any one of (1) to (15), in which

the semiconductor device is configured as an analog computing device.

(17)

The semiconductor device according to (16), in which

the semiconductor device is configured as an array-like analog computing array system in which a plurality of the analog computing devices is arranged in parallel.

(18)

The semiconductor device according to (17), in which

in the analog computing array system, gate electrode units paired with gate units of the analog computing devices arranged in parallel are electrically connected.

(19)

The semiconductor device according to (17) or (18), in which

the analog computing array system is configured corresponding to a product-sum operation of one intermediate layer in a neural network.

### REFERENCE SIGNS LIST

1, 10 Analog computing device
10A Analog computing unit
11 Analog computing array system
20 Control unit
101 Input unit
102 Computing unit
103 Output unit
104 Comparison unit
121 Gate unit
121A, 121A-1, 121A-2 Gate electrode unit
122 Accumulation unit
122A Accumulation electrode unit
124, 124-1 to 124-5 Pair unit
131 Output gate unit
131A Output gate electrode unit
132 Detection unit

1. A semiconductor device comprising:
an input unit that inputs a charge;
a computing unit that accumulates a charge from the input unit and performs an arithmetic operation; and
an output unit that detects and outputs the charge accumulated in the computing unit,
wherein
the computing unit includes an accumulation unit to which a plurality of pair units, each of which is a pair of the input unit and a gate unit, is connected,
each of the plurality of pair units makes a charge input from the input unit to the accumulation unit variable, and
the accumulation unit accumulates a charge input from each of the connected plurality of pair units.

2. The semiconductor device according to claim 1, wherein
the computing unit has a floating region that is not electrically in contact with an outside.

3. The semiconductor device according to claim 1, wherein
the computing unit includes a charge accumulation region forming unit in which a region where a charge is accumulable by an electric field from an outside is formed.

4. The semiconductor device according to claim 1, wherein
the output unit includes an output gate unit and a detection unit,
the gate unit is electrically separated from the input unit and the accumulation unit and switches connection and disconnection between the input unit and the accumulation unit, and
the output gate unit is electrically separated from the accumulation unit and the detection unit and switches connection and disconnection between the accumulation unit and the detection unit.

5. The semiconductor device according to claim 4, wherein
a gate electrode unit and an accumulation electrode unit are paired with the gate unit and the accumulation unit in an electrically non-contact state, respectively, and the gate electrode unit and the accumulation electrode unit are electrically separated.

6. The semiconductor device according to claim 5, wherein
an output gate electrode unit is paired with the output gate unit in an electrically non-contact state, and the gate electrode unit, the accumulation electrode unit, and the output gate electrode unit are electrically separated, and
by individually applying a voltage to the gate electrode unit, the accumulation electrode unit, and the output gate electrode unit, influence of an electric field is given to the gate unit, the accumulation unit, and the output gate unit that are paired with the gate electrode unit, the accumulation electrode unit, and the output gate electrode unit, respectively.

7. The semiconductor device according to claim 6, wherein
by an operation of individually applying a voltage to the gate electrode unit and the accumulation electrode unit and an operation of cutting off the voltage, an electric field is generated or eliminated in each of the gate unit and the accumulation unit paired with the gate electrode unit and the accumulation electrode unit, and thereby the charge from the input unit is input to the accumulation unit via the gate unit and is accumulated.

8. The semiconductor device according to claim 6, wherein
by an operation of individually applying a voltage to the accumulation electrode unit and the output gate electrode unit and an operation of cutting off the voltage, an electric field is generated or eliminated in each of the accumulation unit and the output gate unit paired with the accumulation electrode unit and the output gate electrode unit, and thereby the charge accumulated in the accumulation unit is transferred to the detection unit via the output gate unit and is detected.

9. The semiconductor device according to claim 5, wherein
in each of the plurality of pair units, the input unit includes a resistance element,
in the gate unit paired with the input unit, a voltage determined according to a time from electric connection between the input unit and the accumulation unit to disconnection between the input unit and the accumulation unit is applied to the gate electrode unit paired with the gate unit, and
the accumulation unit accumulates a charge input from the input unit of each of the plurality of pair units according to a voltage applied to the gate electrode unit of each of the connected plurality of pair units.

10. The semiconductor device according to claim 9, wherein
a charge obtained in each of the plurality of pair units is input to the accumulation unit as a result of an integration operation;
the charge input from each of the plurality of pair units is accumulated in the accumulation unit, and all results of the integration operations are added; and
thereby, a product-sum operation is performed.

11. The semiconductor device according to claim 9, wherein
in the output unit, the charge accumulated in the accumulation unit is transferred to the detection unit via the output gate unit and is detected after the input of the charge to the accumulation unit is completed.

12. The semiconductor device according to claim 1, wherein
the gate unit includes a floating region that is not electrically in contact with an outside or a charge accumulation region forming unit in which a region where a charge is accumulable by an electric field from an outside is formed.

13. The semiconductor device according to claim 12, wherein
the floating region or the charge accumulation region forming unit is connected to a floating region of the accumulation unit.

14. The semiconductor device according to claim 5, wherein
the gate unit and the accumulation unit include a semiconductor layer, and
floating regions in the gate unit and the accumulation unit are formed by an electric field generated in the gate unit or the accumulation unit paired with the gate electrode unit or the accumulation electrode unit by applying a voltage to the gate electrode unit or the accumulation electrode unit.

15. The semiconductor device according to claim 4, wherein
the output unit includes a semiconductor layer.

16. The semiconductor device according to claim 1, wherein
the semiconductor device is configured as an analog computing device.

17. The semiconductor device according to claim 16, wherein
the semiconductor device is configured as an array-like analog computing array system in which a plurality of the analog computing devices is arranged in parallel.

18. The semiconductor device according to claim 17, wherein
in the analog computing array system, gate electrode units paired with gate units of the analog computing devices arranged in parallel are electrically connected.

19. The semiconductor device according to claim 18, wherein
the analog computing array system is configured corresponding to a product-sum operation of one intermediate layer in a neural network.
